(19) United States
(12) Patent Application Publication
(10) Pub. No.: US 2024/0424650 A1
(43) Pub. Date: Dec. 26, 2024

(54) Hand Tool

(71) Applicant: BBY Solutions, Inc., Richfield, MN (US)

(72) Inventor: Gary Glover, Lone Grove, OK (US)

(73) Assignee: BBY Solutions, Inc., Richfield, MN (US)

(21) Appl. No.: 18/339,624

(22) Filed: Jun. 22, 2023

(51) Int. Cl. B25B 27/14

(52) U.S. Cl. CPC B25B 27/14

(57) ABSTRACT

A hand tool and its method of use in replacing O-rings or bands of the type used in powered conveyor systems includes a base, shaft and handle. The base is hemispherical in shape and defines at least one a band engagement groove. The shaft extends upward from the base and ends at the handle which is perpendicular with the shaft. The handle has a first cross-sectional area. At least one end of the handle defines a roller axle engagement tip or depressor. The depressor has a second cross-sectional area. The second cross-sectional area being smaller than the first cross-sectional area.

### TECHNICAL FIELD

Embodiments described herein are directed to a specialized hand tool configured for use in the repair and maintenance of roller type conveyor assemblies. More specifically, embodiments are directed to a generally T-shaped hand tool that includes a base which defines at least one O-ring (band) griping surface and a handle portion of which at least one end defines a roller axel depressor.

### BACKGROUND

Many types of conveyor systems (conveyors) exist that are used to transport various goods or materials from one point to another. One type of conveyor is a powered roller conveyor which employs a frame to support a plurality of spaced apart rollers upon which goods can be advanced via the rotation of the rollers. Each roller is a cylindrical tube of rigid material (e.g. stainless steel) mounted on an axle about which the roller tube is freely rotatable. The axle of each roller is supported by opposing side rails of the frame.

In some powered roller conveyors, the roller tubes include one or more indentations or grooves which accommodate the placement of one or more O-rings or bands, with one band extending from one roller tube to an adjacent roller tube in a repeating pattern such that all of the roller tubes are engaged to one another by a pair of bands (excepting the individual roller tubes at the opposing ends of the conveyor, which will have only one band).

The presence and placement of the bands around the rollers increase friction between the rollers and the load (i.e., the goods/materials being conveyed by the conveyor), which prevents slippage of individual load items and helps to maintain alignment and spacing of the load items on the conveyor surface.

The O-rings or bands are typically made of a rubber or similar material such as polyurethane and are available in various durometer values depending on the specific type and/or weight of the load being conveyed. Such materials do not last forever and as such, bands need to be occasionally replaced.

At present, band replacement requires the use of various tools as well as manual manipulation via a technician's fingers/hands to remove a roller from the frame, to brace the roller and pull the existing ring(s) from the roller and then effectuate the replacement of the band(s), etc. Replacing bands in this manner can often result in injury via pinching the fingers or hands during the replacement process and is fairly time consuming.

A need exists for a tool which reduces the need for direct manipulation of the band(s) and/or rollers via the fingers and hands of a replacement technician and which provides for improved efficiency in the task of replacing bands. Embodiments of a tool which meets these needs are described in greater detail below and shown in the accompanying drawings.

### SUMMARY

Embodiments of a tool for use in the replacement of O-rings or bands used in a powered roller conveyor are described below and shown in the accompanying drawings. The tool includes a generally T-shaped shaft mounted handle that extends from a hemi-spherical base portion. The hemi-spherical base includes at least one band engagement groove which is configured to allow the user to grasp, retain and manipulate a conveyor band off of and around a roller during band replacement or other maintenance operations of the conveyor assembly.

In at least one embodiment, at least one end of the handle defines a roller axel engagement tip or depressor. The roller axle engagement tip is sized and shaped to allow the roller axel engagement tip to engage the axle of a roller held within the conveyor frame, thereby pushing or depressing the axle out of engagement with one side of the conveyor frame, thereby allowing the roller and axle to be removed from the frame.

In at least one embodiment, the base portion has a first side and a second side, wherein each side defines at least one band engagement groove. In some embodiments, the groove(s) defined by the first side of the base are the same size and/or shape as the groove(s) defined by the second side of the base. In some embodiments, the groove(s) defined by the first side of the base are a different size and/or shape as compared to the groove(s) defined by the second side of the base. Different sized grooves may accommodate different sized (diameter) bands.

Some embodiments described herein are directed to a method or technique for utilizing the tool to replace bands of a conveyor system. In at least one embodiment the method of band replacement is performed by the following steps:
providing a tool having at least one roller axel depressor and at least one band engagement groove;
using the at least one roller axel depressor to apply pressure to the axle pin of a roller engaged to a conveyor frame, wherein the pressure applied to the axil pin is sufficient to disengage a first end of the roller from the conveyor frame;
lifting the roller to remove the first end of the roller from the frame;
removing a first engaged band from the disengaged roller by sliding the at least one band engagement groove under the first engaged band, and while pulling a second end of the roller free from the frame, using the tool to pull the first engaged band off of the second end of the roller;
releasing the first engaged band from the at least one band engagement groove;
pulling the roller fee from a second engaged band;
repeating the steps above on adjacent rollers to fully remove any engaged band from the rollers as desired.

In some embodiments, the steps provided above are reversed to allow use of the tool to replace bands on to rollers that are lack bands.

### BRIEF DESCRIPTION OF THE DRAWINGS

FIG. 1 is a perspective view of an embodiment of a tool for use in removing and replacing bands of a roller conveyor system.

FIG. 2a is a front facing view of the embodiment shown in FIG. 1, wherein the base of the tool defines a band engagement groove on either side of the handle and the grooves both have the same size.

FIG. 2b is a front facing view of an alternative embodiment to that shown in FIG. 2a, wherein the base of the tool defines a band engagement groove on either side of the handle and wherein each groove is sized to accommodate bands of different diameters.

FIG. 2c is a front facing view of an alternative embodiment to that shown in FIG. 2b, featuring differently sized groves than those shown in FIG. 2b.

FIG. 3 is a front facing partial view of an embodiment of the tool shown next to a roller of a roller conveyer, with one of the band retention grooves engaged to a band.

FIG. 4 is a perspective view of a portion of a roller conveyor system and the embodiment of the tool shown in FIG. 1 and depicts a first step in which the tool may be used to remove and/or replace one or more bands from the rollers of the system.

FIG. 5 is a perspective view of a roller conveyor system and the embodiment of the tool shown in FIG. 1 and depicts the second step in which the tool may be used to remove and/or replace one or more bands from the rollers of the system.

FIG. 6 is a perspective view of a roller conveyor system and the embodiment of the tool shown in FIG. 1 and depicts the third step in which the tool may be used to remove and/or replace one or more bands from the rollers of the system.

FIG. 7 is a perspective view of a roller conveyor system and the embodiment of the tool shown in FIG. 1 and depicts the fourth step in which the tool may be used to remove and/or replace one or more bands from the rollers of the system.

FIG. 8 is a perspective view of a roller conveyor system and the embodiment of the tool shown in FIG. 1 and depicts the fifth step in which the tool may be used to remove and/or replace one or more bands from the rollers of the system.

### DETAILED DESCRIPTION

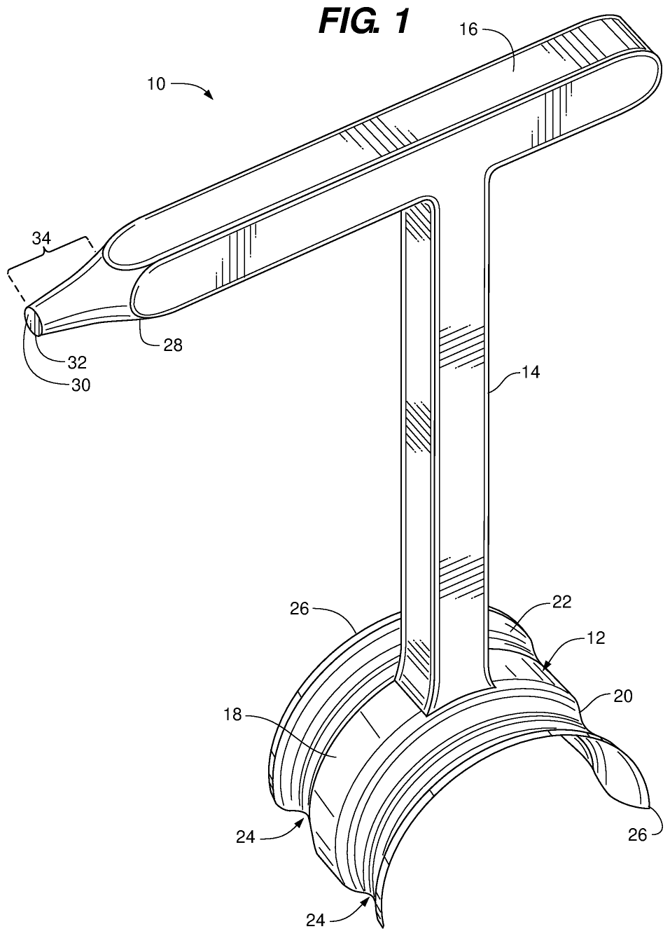

As mentioned above, embodiments shown and described herein are directed to both a tool configured for use in the removal and/or replacement of the O-ring bands (bands) utilized by powered roller conveyor systems as well as the unique replacement technique or method that the tool provides for. Exemplary embodiments of the tool 10, as well as the intended environment of operation for using the tool and its method of operation are shown in FIGS. 1-8.

Turning to FIG. 1 the tool 10 can be seen as being comprised of a hemi-spherical base portion 12 from which a shaft 14 extends. The shaft 14 is topped by a handle 16 that is perpendicular to the shaft 14 to form a generally T-shaped assembly.

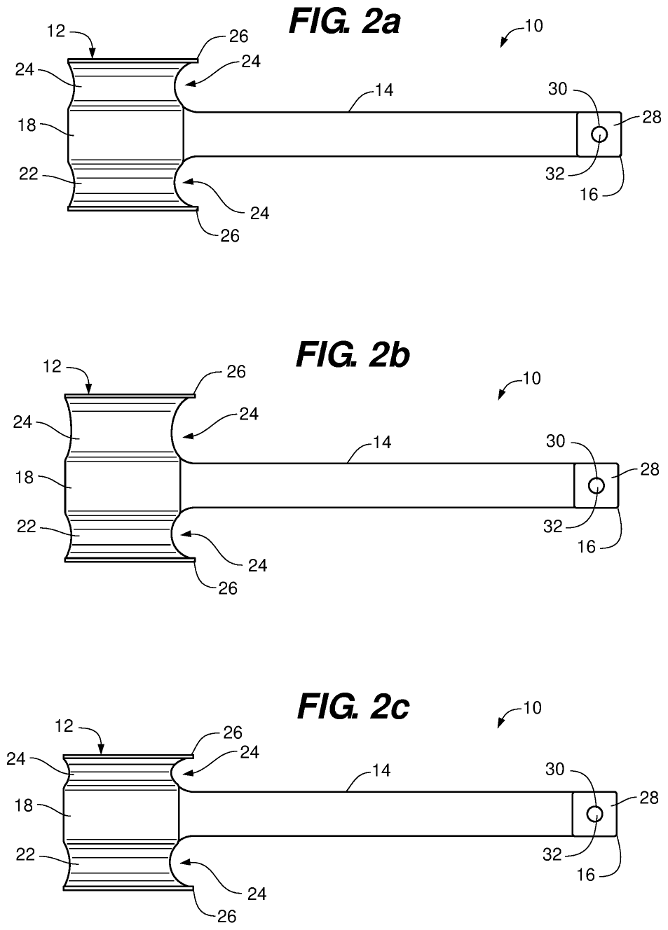

The base portion 12, may be characterized has having three portions including: a middle portion 18 from which the shaft 14 extends, and two side portions 20 and 22. At least one of the side portions 20 and 22 defines a band engagement groove 24 the function and use of the engagement groove(s) is discussed in greater detail below.

Where the tool 10 includes an engagement groove 24 on each of the side portions 20 and 22, such as in the embodiments shown in FIGS. 2a-2c, the grooves 24 may be of the same size and shape, such as in the embodiment shown in FIG. 2a, or they may have different characteristics from one another such as in the embodiments shown in FIGS. 2b and 2c (i.e., the groove 24 defined by the first side portion 20 is larger or smaller than the groove 24 defined by the second side portion 22).

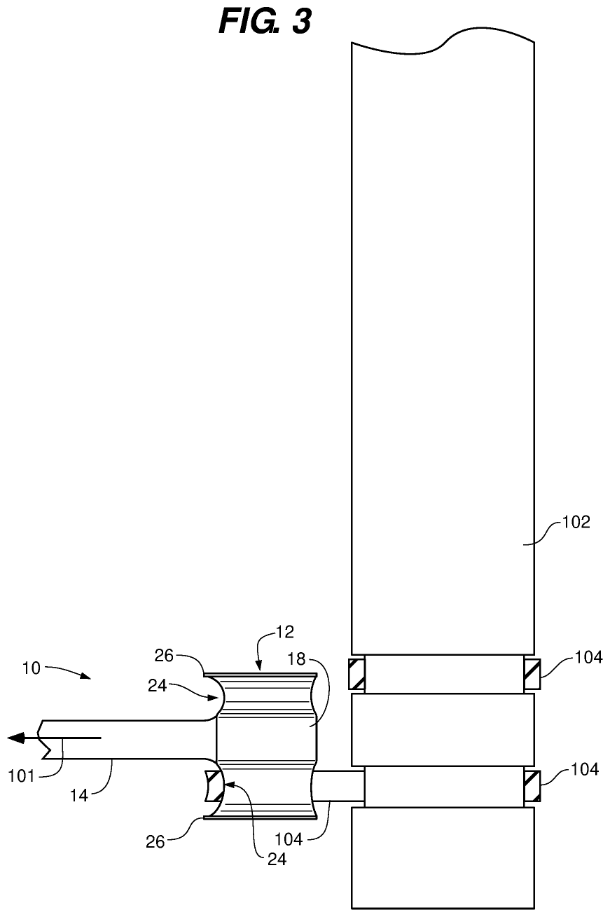

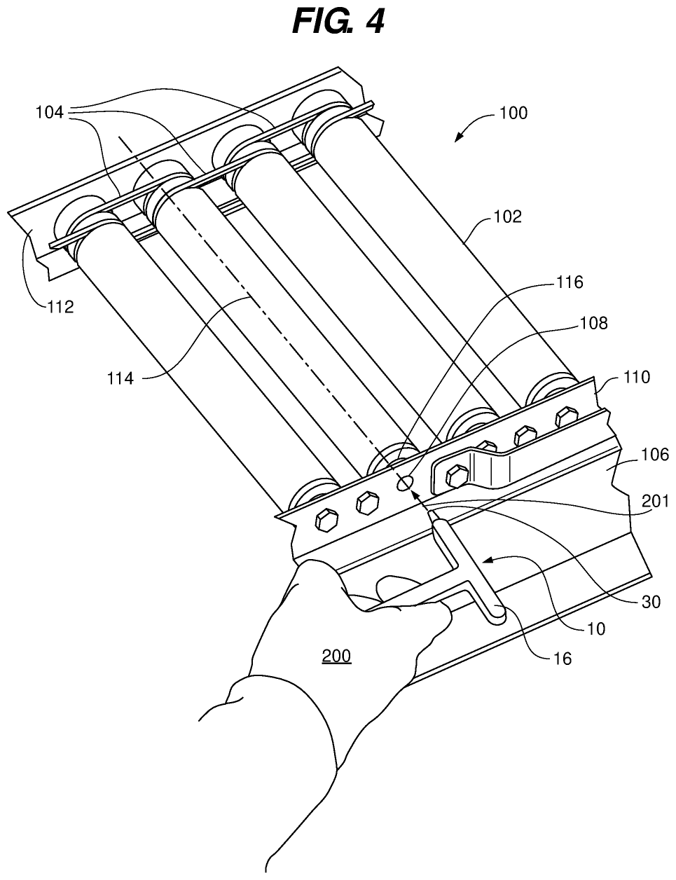

As is shown in FIG. 3, each groove 24 is configured to engage or “grasp” an O-ring or band 104 of the type utilized by a powered conveyor assembly 100 to engage and/or drive the individual rollers 102 of the assembly 100. A partial view of an example of such an assembly is shown in FIGS. 4-8.

Returning to FIG. 3 a roller 102 is shown adjacent to the base portion 12 of the tool 10. Each of the side portions 20 and 22 of the base portion 12 include an outer edge or flange 26 which is configured to engage a band 104 that is disposed under tension about the roller 102 and to allow such a band 104 to slide over the flange 26 and onto and into the groove 24. Once the band 104 is engaged to the groove 24, the band 104 may be stretched away from the roller 102 via a lateral pulling motion (indicated by arrow 101) provided by a user (not depicted in FIG. 3) holding the tool by the handle 16 (see FIG. 1).

Because powered conveyor assemblies are available in different sizes and shapes, and which may utilize a variety of different band types, the tool 10 may be provided with grooves 24 having any of a variety of sizes and shapes (diameters, depths, etc.), so as to accommodate use of the tool 10 with such bands 104 in the manner previously discussed.

In addition to being configured to engage bands 104 of a powered conveyor system 100, the tool 10 includes a feature to assist in disengaging the rollers 102 from the conveyor frame 106 which support them. As may be seen in FIGS. 1 and 4, the handle 16 of the tool 10 is of a generally square cross-sectional shape of a first surface area 28 at least one end of the handle 16 is beveled to form a roller axle engagement tip (depressor) 30 that has a smaller cross-sectional area 32 than the first surface area of the handle 16 proper (this comparison is best shown in FIGS. 2a-2c). In at least one embodiment, the roller engagement tip 30 has a substantially circular shape.

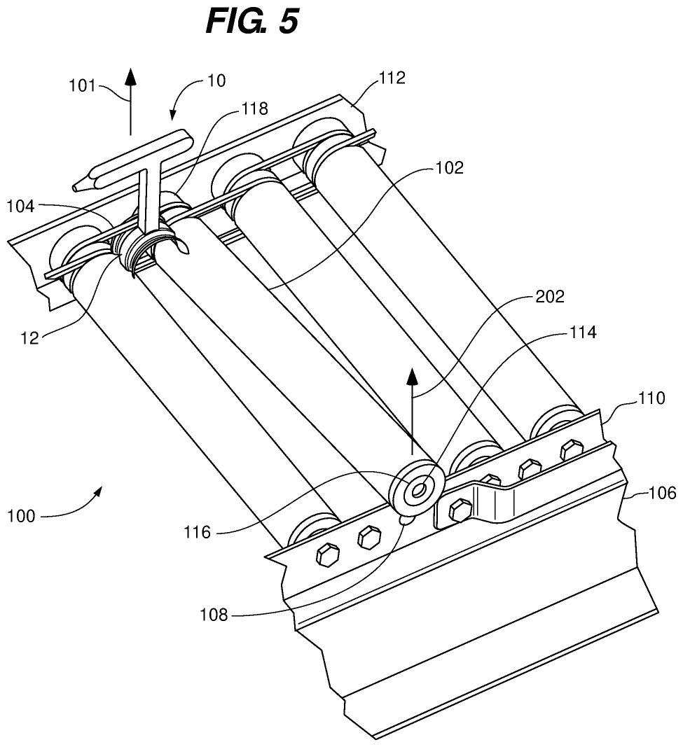

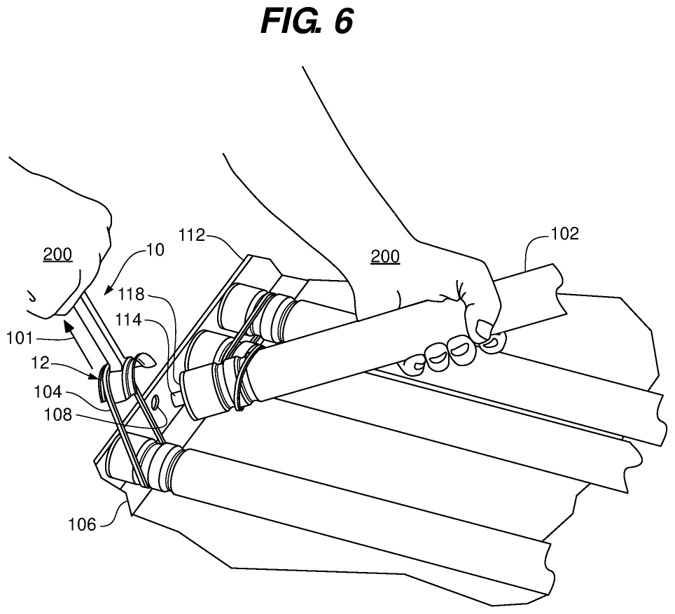

The roller axle engagement tip 30 is configured to engage and pass through a roller axle opening 108 of a conveyor frame 106 in the manner shown in FIG. 4. When assembled as part of the powered conveyor assembly 100, a roller 102 is held between two rails 110 and 112 of the conveyor frame 106 by an axle 114 which engages the axle openings 108. When a user 200 applies pressure (indicated by arrow 201) using the roller axle engagement tip 30 of the tool 10 to a first end 116 of the axle 114 through the axle opening 108 of the first rail 110, the first end 116 of the axle 114, and thereby the roller 102, will be disengaged from the first rail 110 of the frame 106, and may be removed therefrom in the manner shown in FIGS. 5 and 6.

The key characteristic of the roller axle engagement tip 30 is that it is sized appropriately to pass through the axle openings 108 of the conveyor frame 106 side rails 110 and 112 and be of the appropriate size and length to engage and be pushed against (biased) the axle 114 of a roller 102. As such, in embodiments where there is a beveled transition area 34 (see FIG. 1) between the greater handle cross-sectional area 28 to the smaller cross-sectional area 32 of the roller axle engagement tip 30, the beveling may be straight, curved or both.

In at least one embodiment, the roller axle engagement tip 30 is a protrusion of uniform cross-sectional area that protrudes from at least one end of the handle 16 having a greater cross-sectional area.

In a typical powered roller conveyor 100, such as of the type shown in FIGS. 4-8, the conveyor frame 106 supports several rollers 102. The first and last roller of the assembly (i.e., terminal rollers) (not shown) will have a single band 104 disposed thereabout and extending to an adjacent roller. These adjacent rollers 102 and every other roller in the assembly will have two bands 104 disposed about them. One band extends from the roller 102 and the roller to its right, and a second band extends from the roller 102 and the roller to its left, such that all of the rollers in the assembly are mechanically engaged one to the other via the bands 104.

Returning to FIG. 5, it is shown that once the first end 116 of the axle 114 and roller 102 is disengaged from the first rail 110 of the conveyor frame 106 in the manner discussed above, the user 200 (not shown in FIG. 5) may pull the first end 116 of the roller 102 out of engagement with the first rail 110 in the manner indicated by arrow 202. The user then applies the base 12 of the tool 10 to engage one of the bands 104 disposed about the second end 118 of the roller 102 in the manner previously depicted in FIG. 3 and described above.

As is shown in FIG. 6, the band 104 being engaged by the tool 100 may be stretched in the direction indicated by arrow 101 and pulled off and over the roller 102, while the user 200 manually disengages the second end 118 of the roller 102 from the second rail 112 of the conveyor frame 106. By removing the roller 102 fully from the from 106 the remaining band 104 disposed about the roller will be allowed to go slack/relax so that the roller 102 may be pulled from its confines.

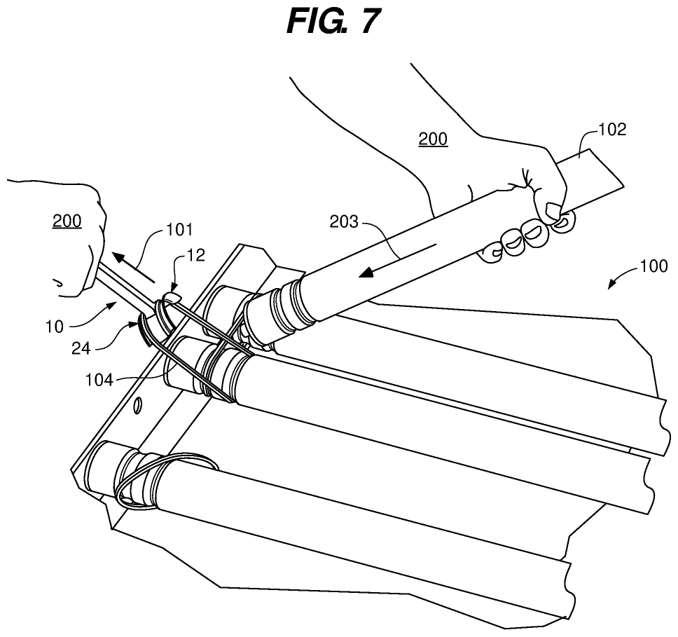

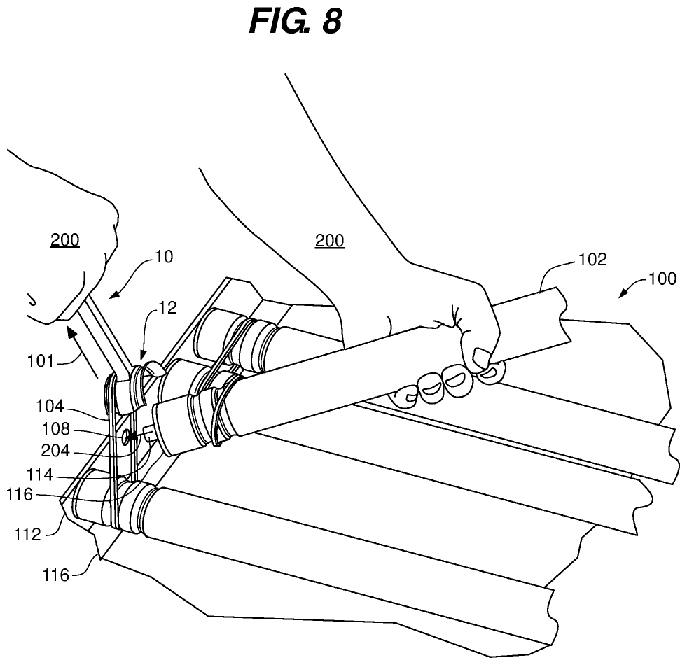

By repeating the steps shown in FIGS. 4-6 any number of bands 104 and/or rollers 102 may be removed from the assembly 100 and presumably be replaced with updated components. Once replacement components have been acquired, the assembly 100 may be reassembled in the manner described below and depicted in FIGS. 7 and 8.

Beginning with FIG. 7, a user 200 using the tool 10, grasps a band 104 using an appropriate groove 24 of the tool base portion 12. Applying sufficient force (as indicated by arrow 101) the band 104 is stretched to the extent necessary to allow the user 200 to insert the roller 102 (as indicated by arrow 203) within the confines of the band 104.

Turning to FIG. 8, the roller 102 now with one band 104 disposed about its second end 118 is held by the user 200 while an adjacent band 104 is tensioned in the same manner as previously described and the roller 102 is passed through the confines of the band 104. Once both bands 104 are disposed about the second end 118 of the roller 102, the axle 114 is passed against/through the axle opening 108 of the second rail 112 in the manner indicated by arrow 204. The first end 116 of the axle 114 and roller 102 are then positioned back into place against the first rail 110 of the frame 116 in reverse of the process shown in FIG. 5 and described above.

While the tool shown and described herein has utility in the servicing and replacing of components of powered conveyor assemblies and systems, it must be noted that the unique features and structure of the tool makes it suitable for numerous other uses.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

1. A hand tool comprising:
a base having a hemispherical shape, the base comprised of a middle portion, a first side portion and a second side portion, at least one of the first side portion and the second side portion defining a band engagement groove;
a shaft, the shaft extending from the middle portion of the base; and
a handle, the handle engaged to an end of the shaft opposite the base, the handle being perpendicular with the shaft, the handle having a first cross-sectional area, at least one end of the handle comprising a depressor, the depressor having a second cross-sectional area, the second cross-sectional area being smaller than the first cross-sectional area.

2. The hand tool of claim 1, wherein the first side portion and the second side portion each define a band engagement groove.

3. The hand tool of claim 1, wherein the band engagement groove defined by the first side portion has a different size than the band engagement groove defined by the second side portion.

4. The hand tool of claim 1, wherein the first cross-sectional area has a square shape.

5. The hand tool of claim 1, wherein the second cross-sectional area has a substantially circular shape.

6. The hand tool of claim 1, wherein the handle defines a beveled region that extends from the first cross-sectional area to the second cross-sectional area.

7. (canceled)

8. (canceled)

9. (canceled)

10. (canceled)

11. (canceled)

12. (canceled)

13. (canceled)

14. (canceled)
